(19) United States
(12) Patent Application Publication
(10) Pub. No.: US 2010/0192525 A1
(43) Pub. Date: Aug. 5, 2010

(54) CLAMPING TRANSFER TURRET

(75) Inventors: Robert Lam, Glen Ellyn, IL (US); Craig Arends, Elgin, IL (US)

Correspondence Address: PAULEY PETERSON & ERICKSON, 2800 W. HIGGINS ROAD, SUITE 365, HOFFMAN ESTATES, IL, 60169, US

(73) Assignee: Illinois Tool Works Inc., Glenview, IL (US)

(21) Appl. No.: 12/688,538

(22) Filed: Jan. 15, 2010

Related U.S. Application Data
(60) Provisional application No. 61/149,247, filed on Feb. 2, 2009.

(51) Int. Cl. B65B 35/56; B65G 37/00; B65G 29/00; B65G 47/86; B65G 47/24

(52) U.S. Cl. 53/544; 198/803.3; 198/803.9; 198/470.1; 198/373

(57) ABSTRACT

A system and apparatus for moving and packaging oriented containers through an application machine and to a container carrier wherein a plurality of containers are fed in a desired rotational position prior to a transfer turret and gripped as the transfer turret rotationally transfers the oriented container to the container carrier.

### CROSS REFERENCE TO RELATED APPLICATION

This application claims the benefit of U.S. Provisional Application No. 61/149,247 filed on 2 Feb. 2009. This Provisional Application is hereby incorporated by reference herein in its entirety and is made a part hereof, including but not limited to those portions which specifically appear hereinafter.

### BACKGROUND OF THE INVENTION

1. Field of the Invention

This invention relates to a system and method for transferring containers in an oriented manner for unitization with a container carrier.

2. Description of Prior Art

Container carriers are often thermoplastic ring-type carriers, commonly called “six-pack” rings, that unitize a plurality of containers into a single package. Cardboard, paperboard and plastic shrink wrap are also commonly used to unitize a plurality of containers. The unitized containers are generally randomly oriented so that each container is positioned in a different rotational orientation within the carrier. This random orientation may result in an arbitrary appearance of the package, particularly the container's trademark and graphics. In addition, it is often preferable to ensure that UPC labels on the respective containers are oriented correctly, either facing inward or outward.

According to one method known in the art, individual containers are rotated, either manually or mechanically, into a preferred orientation after packaging randomly oriented containers in the container carrier. Rotation of the containers once the containers are engaged within the container carrier may destroy the integrity of the container carrier through excessive torque applied to the respective thermoplastic rings within the container carrier. Alternatively, rotation of the containers may be impossible once the containers are sealed within other packages known to those having ordinary skill in the art.

Therefore, a need exists for a system and method of orienting containers within a package without destroying the integrity of the carrier or slowing the packaging process.

### SUMMARY OF THE INVENTION

This invention relates to a system and method for packaging oriented containers in a container carrier, such as in a thermoplastic ring carrier, a paperboard box-style carrier or a plastic shrink wrapped carrier. The system preferably cooperates with an inlet conveyor and a packaging machine. A plurality of containers are preferably fed through an orienter or are otherwise oriented prior to conveyance to application of the container carrier to the containers. The orienter is preferably positioned to rotate each container into a proper orientation and then move each container from the inlet of system toward the packaging machine.

Preferably a transfer turret according to this invention is positioned between the orienter and the packaging machine and comprises a plurality of fingers arranged circumferentially around the transfer turret. The plurality of finger are preferably arranged in a plurality of corresponding finger pairs that are each moveable between an open position and a clamped position for gripping a container of the plurality of containers. As each oriented container enters the transfer turret, the finger pairs preferably clamp around a cap or upper portion of the respective oriented container thereby preventing additional rotational movement. The oriented container is then conveyed around the transfer turret while maintaining the desired rotational position.

The oriented containers are then either moved directly into position for application of the container carrier to the oriented containers or are engaged with a transfer belt connected with respect to the transfer turret. The transfer belt preferably transfers an oriented container in a fixed rotational position from the transfer turret to the packaging machine. The transfer belt may include a plurality of pockets spaced to receive oriented containers from the orientation wheel. The plurality of pockets may comprise a tactile material so as to grip oriented containers and prevent any rotation out of an oriented position. In addition, the transfer belt must grip with sufficient force to prevent rotation as the container slides along a stationary floor or against a stationary wall.

The transfer turret and/or the transfer belt then feeds oriented containers directly to the packaging machine, for instance, an application drum for applying individual container carriers to groups of oriented containers. In one application for the system according to this invention, the application drum includes a plurality of jaws positioned to apply the container carrier over two or more oriented containers resulting in a package of properly oriented containers. Alternatively, the packaging machine may include other arrangements, such as paperboard loaders, known to those having ordinary skill in the art. The orientation of each respective container may be adjusted relative to adjacent containers to match the configuration of the container carrier.

### BRIEF DESCRIPTION OF THE DRAWINGS

The above-mentioned and other features and objects of this invention will be better understood from the following detailed description taken in conjunction with the drawings wherein:

FIG. 1 is a front view of a package having a plurality of oriented containers, according to one preferred embodiment of this invention;

FIG. 2 is a top view of a packaging system, according to one preferred embodiment of this invention;

FIG. 3 is a top view of a transfer turret in operation, according to one preferred embodiment of this invention;

FIG. 4 is a side perspective view of a pair of transfer turrets and transfer belts, according to one preferred embodiment of this invention;

FIG. 5 is a front perspective view of a transfer turret, according to one preferred embodiment of this invention; and

FIG. 6 is a side view of the transfer turret shown in FIG. 5.

### DESCRIPTION OF PREFERRED EMBODIMENTS

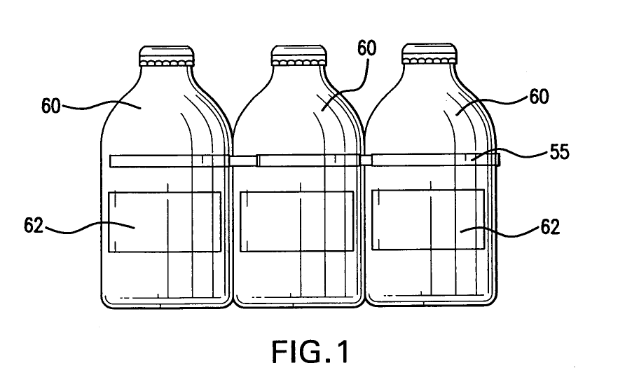

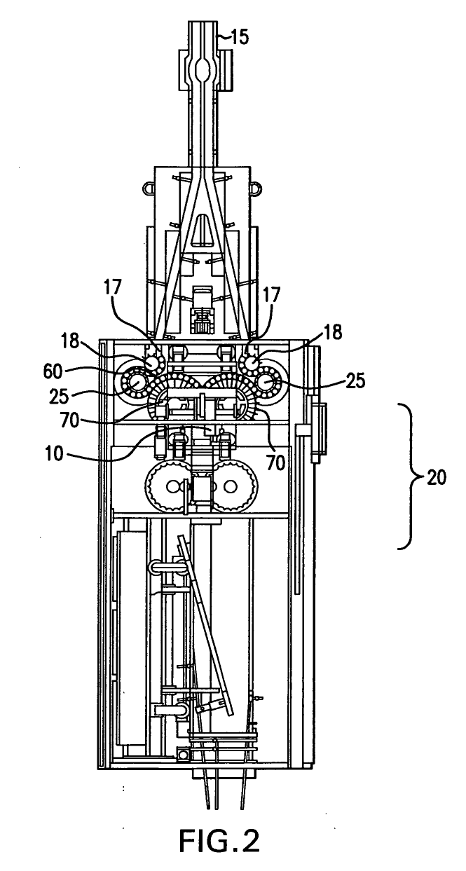

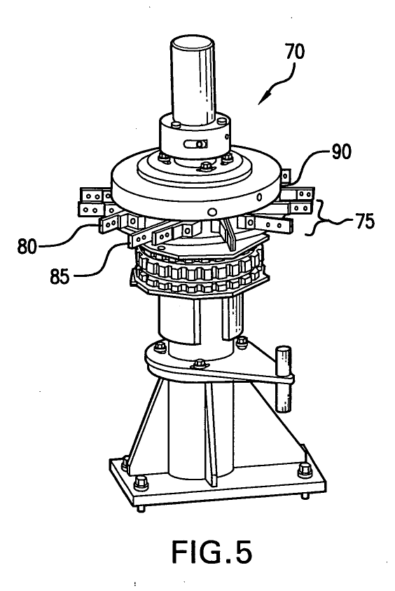

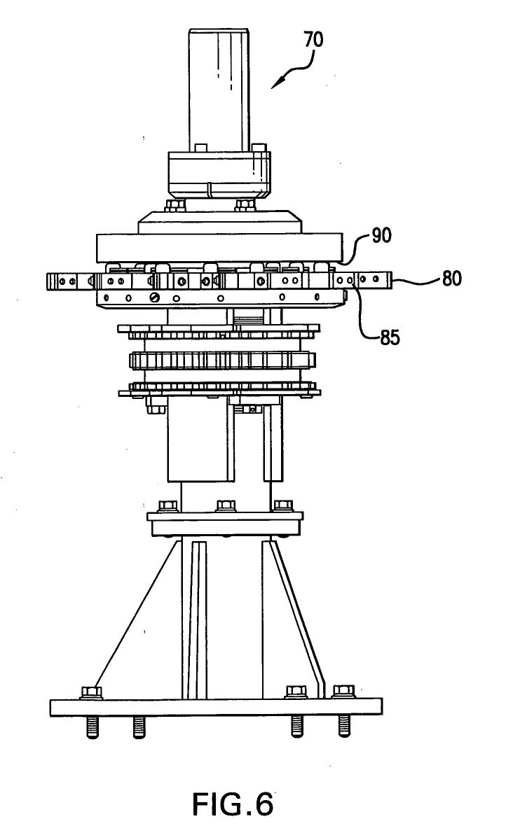

FIG. 1 shows a package and FIGS. 2-6 show a system for use with a packaging machine for transfer of oriented containers resulting in such a package. According to a preferred embodiment of this invention, oriented containers 60 are transferred in a fixed rotational position to a packaging machine whereby a container carrier 55 is applied to a plurality of oriented containers 60, such as shown in FIG. 1. A resulting package as shown in FIG. 1 preferably includes a plurality of oriented containers 60, for instance, such that each container 60 includes label 62 that is rotationally aligned in a consistent and/or desired position.

The system is preferably used in connection with traditional packaging machines for applying container carrier 55 to a plurality of containers 60. Container carriers 55 may be, though not necessarily, formed from an elastic thermoplastic material having a plurality of container receiving openings, each for engaging a container 60. Alternatively, other packaging known to those having ordinary skill in the art, such as paperboard and shrinkwrap may be used in connection with the system.

As shown in FIG. 2, the system according to one preferred embodiment of this invention preferably cooperates with inlet conveyor 15 and packaging machine 20. Inlet 17 of the system preferably accepts a plurality of containers 60 from inlet conveyor 15. Inlet 17 may comprise inlet wheel 18 for transfer and possible singularization of containers 60 from inlet conveyor 15 to orienter 25. According to one preferred embodiment of this invention, inlet conveyor 15 provides two single file rows of containers 60 to inlet 17 of the system.

The plurality of containers 60 from inlet conveyor 15 are preferably fed into inlet 17 of orienter 25. Inlet 17 may comprise inlet wheel 18 to space and singularize containers 60 prior to receipt by orientation wheel 25. Orientation wheel 25 is positioned to rotate each container 60 into a proper orientation and at the same time move each container 60 from inlet 17 of system toward packaging machine 20. Preferably, orienter 25 is generally round and includes a plurality of circumferential orientation stations configured to accept one container 60 of the plurality of containers 60. Therefore, orienter 25 preferably initiates or maintains singularization of the plurality of containers 60. Orienter 25 is not necessarily generally round and is susceptible to any other embodiment that permits singularization of containers 60.

As further shown in FIG. 2, orienter 25 then preferably passes the oriented containers 60 to transfer turret 70. Transfer turret 70 subsequently transfers the oriented containers 60 to application drum 10. Alternatively, transfer turret 70 may pass each oriented container to transfer belt 40, as described herein. Application drum 10 then places container carrier 55 into engagement with the plurality of containers.

Transfer turret 70 preferably directs containers 60 positioned in a desired rotational, or oriented, position from orienter 25 to packaging machine 20. Each set of finger pairs 75 of transfer turret 70 preferably accommodates an oriented container 60 and maintains the desired rotational position of container 60 from orienter 25 to the container carrier 55 in packaging machine 20. Unlike other embodiments described hereafter, the subject embodiment does not require a transfer belt 40 or similar device as the oriented containers 60 are passed directly from transfer turret 70 to application drum 10 of packaging machine 20. Such direct transfer minimizes potential for losing the orientation of each oriented container 60.

Transfer turret 70 preferably moves the plurality of oriented containers 60 in a fixed desired rotational position from a capture position to a release position around a perimeter of transfer turret 70. The plurality of finger pairs 75 are arranged circumferentially around the perimeter of transfer turret 70 so that each finger pair 75 is moveable between an open position and a clamped position for gripping an oriented container 60 and moving the oriented container 60 in the desired rotational position to or towards the container carrier 55.

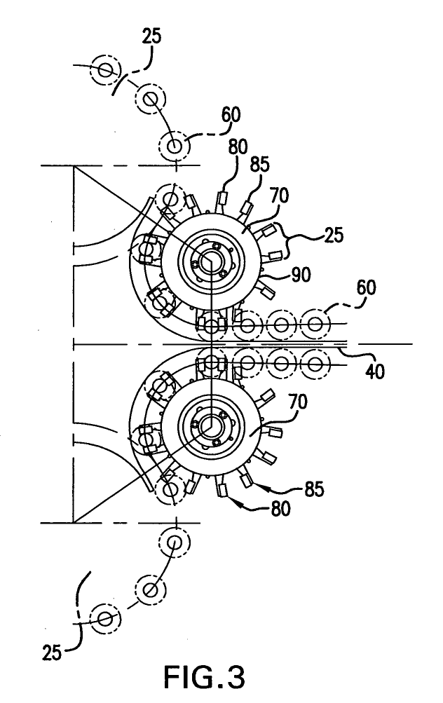

As best shown in FIG. 3, each finger pair 75, particularly first finger 80 and second finger 85, preferably moves between the open position and the clamped position at a different time than an adjacent finger pair 75, as transfer turret 70 rotates about its axis. Likewise, each finger pair 75 preferably moves between the clamped position and the open position at a different time than an adjacent finger pair 75. According to one preferred embodiment of this invention, transfer turret 70 includes cam 90. First finger 80 and second finger 85 of each finger pair 75 are preferably connected with respect to the cam 90 such that finger pairs 75 reciprocate between the clamped position and the open position as transfer turret 70 rotates about its axis.

As a result, oriented container 60, such as a bottle, and more specifically a top portion of the bottle, is firmly engaged between pairs of fingers 80, 85.

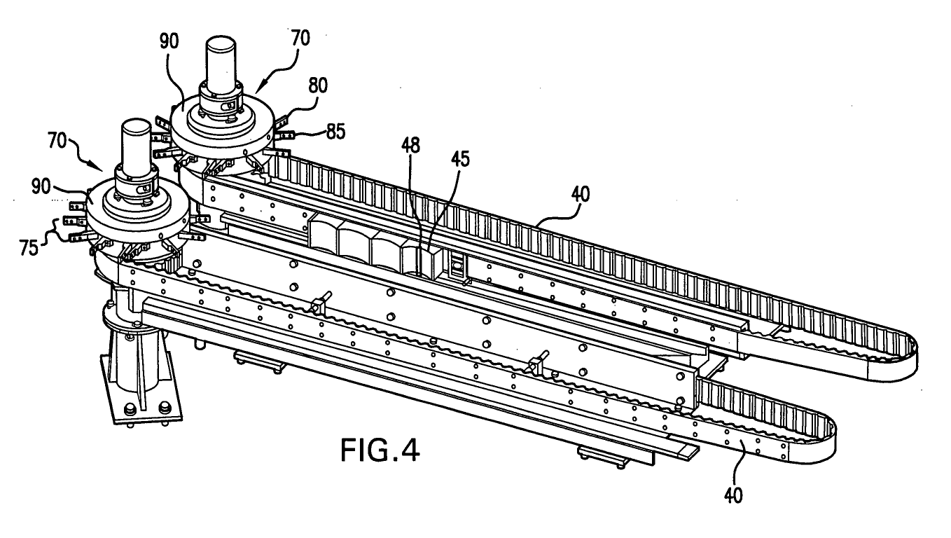

As shown in FIGS. 3 and 4, according to one preferred embodiment of this invention, transfer belt 40 is connected with respect to orientation wheel 25. Transfer belt 40 transfers an oriented container 60 in a fixed rotational position from transfer turret 70 to packaging machine 20, specifically to application drum 10. Transfer belt 40 preferably grips oriented container 60 with sufficient force to prevent rotation as oriented container 60 slides along a stationary floor or against a stationary wall of the system.

As partially shown in FIGS. 2-4 and 6, a system according to this invention preferably comprises two orienter 25, two transfer turrets 70 and two transfer belts 40 which together result in the orientation and transfer of two rows of containers 60. This arrangement speeds up the packaging process and also cooperates with typical packaging machines 20 that accept two rows of containers 60.

As shown in FIG. 4, according to one preferred embodiment of this invention, transfer belt 40 comprises a plurality of pockets 45 spaced to receive oriented containers 60 from orientation wheel 25. The plurality of pockets 45 are preferably tactile so as to grip oriented containers 60 and prevent any rotation out of an oriented position. Pockets 45 may further include resilient insert 48 positioned in each pocket 45. Transfer belt 40 may be positioned adjacent a slide plate or rail positioned along a path of travel of transfer belt 40. Each oriented container 60 is preferably wedged between resilient insert 48 and the slide plate or rail thereby maintaining the rotational position of container 60 as container 60 is moved toward packaging machine 20. The slide plate or rail preferably includes a smooth surface or coating such as TEFLON to permit the oriented containers 60 to slide freely without disrupting the rotational position.

Transfer belt 40 preferably feeds oriented container 60 from transfer turret 70 directly into packaging machine 20. Alternatively, as described above, transfer turret 70 may feed oriented containers 60 directly into packaging machine 20. Packaging machine 20 may include an application drum 10 having a plurality of jaws positioned to apply container carrier 55 over two or more oriented containers 60.

While in the foregoing specification this invention has been described in relation to certain preferred embodiments thereof, and many details have been set forth for purpose of illustration, it will be apparent to those skilled in the art that the system and method according to this invention are susceptible to additional embodiments and that certain of the details described herein can be varied considerably without departing from the basic principles of the invention.

We claim:

1. A transfer turret for moving a plurality of containers to a container carrier in a desired rotational position, the transfer turret comprising:
a plurality of fingers arranged circumferentially around the transfer turret in a plurality finger pairs, each finger pair of the plurality of finger pairs moveable between an open position and a clamped position for gripping a container of the plurality of containers and moving the container in the desired rotational position to the container carrier.

2. The transfer turret of claim 1 wherein each finger pair moves between the open position and the clamped position at a different time than an adjacent finger pair.

3. The transfer turret of claim 1 wherein each finger pair moves between the clamped position and the open position at a different time than an adjacent finger pair.

4. The transfer turret of claim 1 further comprising:
a cam;
a first finger of the finger pair connected with respect to the cam; and
a second finger of the finger pair connected with respect to the cam so that the first finger and the second finger move between the open position and the clamped position as the finger pair moves around the transfer turret.

5. The transfer turret of claim 1 further comprising:
a transfer belt connected with respect to the transfer turret, the transfer turret accepting oriented containers from the transfer turret.

6. A system for transferring a container in a desired rotational position prior to placement in a container carrier, the system comprising:
an inlet for providing a plurality of containers;
an orienter for placing the container in the desired rotational position;
a transfer turret in communication with the orienter, the transfer turret including a plurality of fingers arranged circumferentially around the transfer turret in a plurality finger pairs, each finger pair of the plurality of finger pairs moveable between an open position and a clamped position for gripping the container and moving the container in the desired rotational position to the container carrier.

7. The system of claim 6 wherein each finger pair moves between the open position and the clamped position at a different time than an adjacent finger pair.

8. The system of claim 6 wherein each finger pair moves between the clamped position and the open position at a different time than an adjacent finger pair.

9. The system of claim 6 further comprising:
a cam;
a first finger of the finger pair connected with respect to the cam; and
a second finger of the finger pair connected with respect to the cam so that the first finger and the second finger move between the open position and the clamped position as the finger pair moves around the transfer turret.

10. The system of claim 6 further comprising a pair of transfer turrets for receiving two columns of containers.

11. The system of claim 6 further comprising an outlet conveyor positioned between the transfer turret and the container carrier.

12. The system of claim 11 wherein the outlet conveyor comprises a plurality of pockets, each pocket moving an oriented container from the transfer turret to the container carrier.

13. The system of claim 12 further comprising:
a resilient insert positioned in each pocket of the plurality of pockets.

14. A system for packaging oriented containers in a container carrier, the system receiving a plurality of unoriented containers at an inlet, the system comprising:
an orienter wheel connected with respect to the inlet that moves the plurality of unoriented containers into a desired rotational position;
a transfer turret in communication with the orienter, the transfer turret including a plurality of fingers arranged circumferentially around the transfer turret in a plurality finger pairs, each finger pair of the plurality of finger pairs moveable between an open position and a clamped position for gripping a container in the desired rotational position and moving the container in the desired rotational position to the container carrier; and
a packaging machine for placing the container carrier around a plurality of oriented containers.

15. The system of claim 14 further comprising:
an outlet conveyor positioned directly adjacent to the transfer turret, the outlet conveyor having a plurality of pockets for transferring the oriented containers to the container carrier.

16. The system of claim 15 wherein each pocket of the plurality of pockets includes an insert for maintaining the oriented position of the oriented container.
